(19) United States
(12) Patent Application Publication
(10) Pub. No.: US 2025/0289542 A1
(43) Pub. Date: Sep. 18, 2025

(54) Full Face Snorkel Mask Communication System

(71) Applicant: Elaine Rae Sibert, Rancho Palos Verdes, CA (US)

(72) Inventor: Elaine Rae Sibert, Rancho Palos Verdes, CA (US)

(21) Appl. No.: 18/608,721

(22) Filed: Mar. 18, 2024

(51) Int. Cl. B63C 11/26; B63C 11/12; B63C 11/16; H04B 13/00

(52) U.S. Cl. CPC B63C 11/26; B63C 11/16; B63C 2011/121; H04B 13/00

(57) ABSTRACT

The present invention relates to a full-face snorkel mask for underwater use with a communication system comprising a Wi-Fi antenna affixed to the breathing tube which is wired directly to a computer contained in a waterproof case positioned on the snorkeler, two microphones, a speaker, biometric sensors, a camera in a waterproof case mounted to the top of the mask, and a control button. An internet connection and wireless local area network are generated and broadcast by the computer on the snorkeler or by a buoy system computer, enabling two-way audio, video, and data communication between two or more snorkelers and a third-party monitor, as well as biometric sensor data monitoring, and GPS location tracking.

### BACKGROUND OF THE INVENTION

The present invention relates to the field of a system and apparatus of a communication system integrated with a full-face snorkel mask used for snorkeling, a popular hobby where a user can float on the surface of the ocean while viewing the marine life underneath. Snorkeling allows people to glimpse the underwater world and witness wildlife in its natural habitat. The full-face snorkel mask consists of two compartments, a main upper one in the eye area and cheekbones and a lower oronasal one that is associated with the user's nose and mouth. These two compartments are separated by a wall provided with air valves. A full-face mask of this type is described in patent U.S. Pat. No. 11,352,108 B2, a full-face diving mask having a breathing tube. ₍₁₎ By way of the design of the full-face snorkel mask, the snorkeler has their mouth free which allows the user to speak within the lower chamber of the mask. However, this does not allow for communication with other snorkelers or a person on a boat or on shore while the snorkeler has their head underwater.

Providing said full-face snorkel masks with a telecommunication device is also known, for example as described in patent U.S. Pat. No. 11,667,362B2, a full-face snorkel mask that includes a telecommunications device which is mounted at least partially to the breathing tube. ₍₂₎ The current invention affixes microphones inside both the upper and lower chambers of the full-face snorkel mask that are wired directly to a computer in a waterproof case positioned on the snorkeler (herein to be known as CPS), which processes and creates noise-cancelling audio, allowing snorkelers to send said audio to other snorkelers and third-party monitors.

Various embodiments in patent U.S. Pat. No. 11,667,362B2 of a full-face snorkel mask telecommunication device provide wireless communication between more than one snorkeler using ultrasound and Bluetooth™ technology. ₍₃₎ An embodiment of the current invention uses a Wi-Fi wireless local area network (herein to be known as a WLAN) generated by said CPS positioned on said snorkeler, which generates a connection to the internet and broadcasts said connection via the WLAN antenna of said snorkeler, which enables snorkel unit users in a group to connect to one another and the internet and a third-party monitor on said WLAN or remotely via the internet.

A prior embodiment of an underwater communication device with a buoy system was defined in patent US20180376245-A1, wherein communication was facilitated between one or more divers and a surface ship buoy system with a communication device incorporated into a buoy, or an array of buoy communication devices towed by a ship. ₍₄₎ Prior embodiments of the buoy system relied on ultrasonic technology and a mouthpiece placed inside the mouth of the diver or snorkeler, along with a synthesizer for voice processing. ₍₅₎ An embodiment of the current invention comprises a full-face snorkel mask wherein the snorkeler has their mouth free, allowing the user to speak within the lower chamber of the mask, with two microphones inside the mask and a bone-conducted speaker, all of which are wired directly to a CPS, which enables snorkel units to send and receive clear, noise-cancelling audio. An embodiment of the current invention comprises a buoy system computer (herein to be known as BSC) with an internet connection, generating and broadcasting a Wi-Fi WLAN, which enables snorkel unit users to connect to one another and the internet, two-way audio, video and data communication between snorkelers and a third-party monitor and monitoring of all snorkel units by a third-party monitor with access to the BSC or remotely via the internet, as well as extending the signal range of the system.

The applicant has made the observation that prior attempts to create a system and apparatus for a communication device for snorkeling, may not provide ambient noise-cancelling audio communication, video sharing to the internet, a Wi-Fi WLAN created by an individual snorkeler's CPS or a BSC with the ability to interface with the internet, generate and broadcast a WLAN, nor provide for monitoring of GPS location tracking and biometric data of said snorkelers by a third-party monitor.

Therefore, the objective of the applicant is to provide a system and apparatus of a full-face snorkel mask communication system (herein to be known as FFSMCS) that enables communication between two or more snorkelers, a third-party monitor and a plurality of snorkelers, as well as an internet connection which is generated by either a CPS or by a BSC, that broadcasts a Wi-Fi WLAN which connects to said snorkel units via a WLAN antenna affixed to the full-face snorkel mask breathing tube that is wired directly to said CPS. The FFSMCS provides noise-cancelling audio communication, video sharing, biometric sensor data monitoring, as well as GPS location tracking. A monitor of said BSC, or a third-party connected remotely via the internet, is able to monitor the health and safety of each snorkeler, locate and track everyone in the snorkeling group, as well as send and receive alerts, all of which provide an extra measure of safety for snorkelers.

### BRIEF SUMMARY OF THE INVENTION

The following outlines certain features of embodiments of the Full-Face Snorkel Mask Communication System such that the detailed description of the invention that follows may be better understood. Additional features of embodiments of the present FFSMCS invention will be described hereinafter. It should be appreciated by those skilled in the art that the general concepts and the specific embodiments disclosed herein may be readily utilized as bases for modifying or designing other embodiments for carrying out the same or similar purposes of the present invention. It should also be realized by those skilled in the art that such equivalent embodiments do not depart from the spirit and scope of the invention, as set forth in the appended claims.

It is the objective of the FFSMCS invention to create a system and apparatus for underwater voice, data, and image communication for a full-face snorkel mask, which connects said FFSMCS snorkelers with other FFSMCS snorkelers, and with a monitor on the surface, comprising: a full-face snorkel mask with an upper chamber and a lower chamber; a Wi-Fi antenna affixed to the top of the snorkel mask breathing tube, wired directly to said computer positioned on snorkeler in a waterproof case (CPS), and a buoy system computer (BSC), connected to the internet, generating and broadcasting a WLAN; two waterproof microphones, one contained within the upper chamber and the second contained in the lower chamber of said full-face snorkel mask, with a wired connection to said CPS; a bone-conducting speaker positioned on a strap on the back of said full-face snorkel mask, pressed against the skull of the user, with a wired connection to said CPS; a biometric sensor inside the upper chamber of said full-face snorkel mask which would press against the skin of the user, with a wired connection to said CPS; a push to talk button incorporated into the front of said full-face snorkel mask with a wired connection to said CPS; a camera in a waterproof case attached to the top of said full-face snorkel mask with a wired connection to said CPS.

An embodiment of the FFSMCS comprises a CPS which can be any of the following devices with a connection to the internet: a Raspberry Pi computer, an Arduino computer, a Nvidia computer, a smart cellular phone, or other similar computers.

An embodiment of the FFSMCS further comprises a Wi-Fi WLAN internet connection which is generated and broadcast by said CPS of an individual snorkeler.

An embodiment of the FFSMCS further comprises a Wi-Fi WLAN internet connection which is generated and broadcast by a BSC on at least one of the following configurations: a surface-ship buoy, on a land buoy, or on a stand-alone floating buoy.

An embodiment of said BSC further comprises at least one of the following: a laptop computer, or a desktop computer.

An embodiment of said BSC further comprises at least one of the following: a WLAN router, a WLAN-to-WLAN bridge extender, a LoRaWAN, a satellite interface, a smart phone cellular connection, a NOAA radio broadcast, and/or a COSPAS-SARSAT satellite distress system.

An embodiment of the FFSMCS BSC comprising a connection to cloud system software enabling: SIP/VOIP audio communication, noise-cancellation audio processing, a SOS signal broadcaster, a data sharing platform, biometric sensor data monitoring, GPS location tracking data as well as image and video capture, sharing, and transfer capabilities.

An embodiment of the FFSMCS enables a third-party monitor connected to said WLAN or remotely to the internet, the ability to manage the following with a plurality of snorkel units: send and receive audio, video and data communication between the monitor and snorkel units; communication between snorkel units; GPS location tracking of each snorkel unit; access and monitoring of biometric sensors of snorkel units; sending and receiving alarms or emergency alerts; and enabling cloud broadcasting and interface for snorkel units.

### BRIEF DESCRIPTION OF THE DRAWINGS

The system, apparatus, and method of the FFSMCS will be better understood on reading the following descriptions of various embodiments of the disclosure given as a non-limited example with reference to the appended drawings in which:

FIG. 1 is a perspective view of the system, apparatus, and methods comprising the FFSMCS integrated with an existing full-face snorkel mask;

FIG. 2 is a front view of said FFSMCS shown in FIG. 1;

FIG. 3 is a rear view of said FFSMCS shown in FIG. 1;

FIG. 4 is a side view of said FFSMCS shown in FIG. 1;

FIG. 5 is the other side view of said FFSMCS shown in FIG. 1;

FIG. 6 is a perspective view of the wiring of components that are encapsulated into a waterproof plug and grouped in an umbilical cable which is wired directly into said CPS of said FFSMCS shown in FIG. 1;

FIG. 7A is a perspective view of a snorkeler with an umbilical cable exiting the mask, wired directly into said CPS of said FFSMCS shown in FIG. 1, positioned on an arm band strap on the snorkeler.

FIG. 7B is a perspective view of a snorkeler with an umbilical cable exiting the mask, wired directly into said CPS of said FFSMCS shown in FIG. 1, coupled to the waist of the snorkeler's bathing suit or wetsuit.

FIG. 8A is a schematic view of an embodiment of said FFSMCS in FIG. 1 with said CPS coupled on the waist as shown in FIG. 7b, utilizing a surface-ship BCS with an internet connection, generating a WLAN, and a third-party monitor with direct access to said BSC.

FIG. 8B is a schematic view of an embodiment of said FFSMCS in FIG. 1 with said CPS coupled on the waist as shown in FIG. 7b, utilizing a land based BCS with an internet connection, generating a WLAN, and a third-party monitor with direct access to said BCS.

FIG. 8C is a schematic view of an embodiment of said FFSMCS in FIG. 1 with said CPS coupled on the waist as shown in FIG. 7b, utilizing a stand-alone floating BCS with an internet connection, generating a WLAN, and a remote third-party monitor connected to the internet.

### DETAILED DESCRIPTION

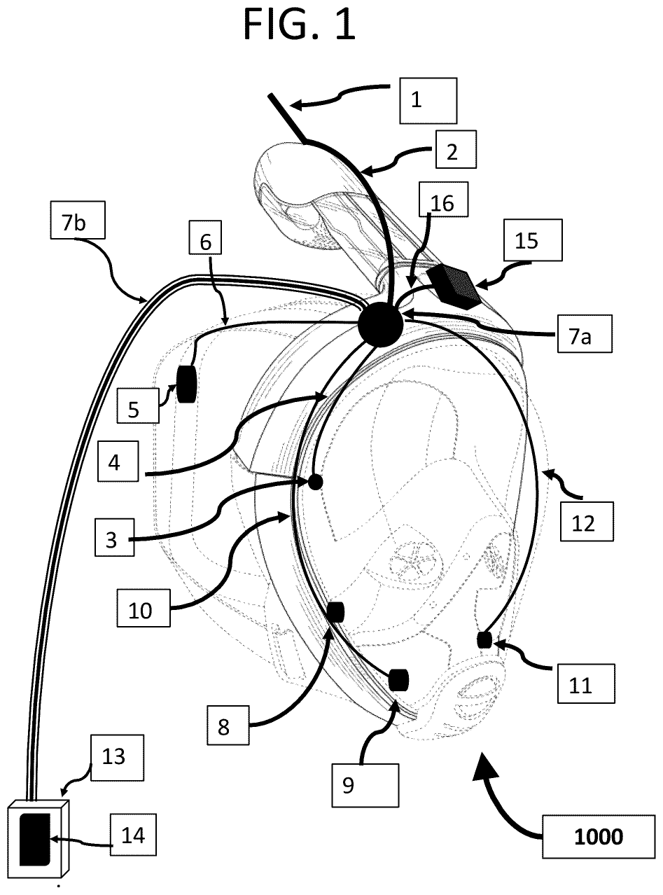

FIGS. 1-8c illustrate embodiments of the FFSMCS conforming to the present disclosure. With reference to the aforementioned drawings, a full-face snorkel mask 1000 is shown which comprises a transparent visor and consists of two compartments, an upper chamber in the eyes and cheekbones area for viewing and a lower oronasal breathing chamber which allows the snorkeler to speak with their mouth, including a partition plate that separates the two chambers, a frame with a seal made of silicon to ensure a water-tight seal, suitable straps to fit the mask on the face of a snorkeler, a snorkel breathing tube upwardly extended from the top of said mask.

FIG. 1, illustrates an embodiment of the FFSMCS comprising a full-face snorkel mask 1000 with a Wi-Fi antenna 1 fixed to the top of said full-face snorkel mask breathing tube, positioned so that said antenna is above water while the face and visor of said snorkel mask is underwater, then wired along the breathing tube into the mask 2, which is grouped in an umbilical cable 7b, plugging into a computer 14 within a waterproof case 13 positioned on the snorkeler with a rating commonly known as IPX8 which is described as protected against continuous immersion to a depth of 30 ft/10 m (herein to be known as waterproof), which enables a connection between a plurality of snorkeler units, as well as snorkel units and a third-party monitor via a WLAN.

In various embodiments the FFSMCS as shown in FIG. 1 further comprises biometric sensors 3 affixed to the inside of the upper chamber of the full-face snorkel mask 1000, making contact with the skin of the snorkeler, wired inside 4 said mask, encapsulated into a waterproof plug 7a, exiting said mask in an umbilical cable 7b, plugging directly into a computer 14 within a waterproof case 13 positioned on the snorkeler, which allows a third-party to monitor the health, safety and location of snorkelers connected to the WLAN.

In various embodiments the FFSMCS as shown in FIG. 1 further comprises two-way audio communication between a plurality of snorkelers and a third-party monitor connected to a WLAN comprising: a bone-conducting transducer speaker 5 attached to the back head strap of the full-face snorkel mask 1000, making contact with the skull of the snorkeler and wired along the head strap 6; two waterproof microphones fixed to the inside of said mask, one contained within the upper chamber 8 of said mask and the second waterproof microphone contained within the lower chamber 9 of said mask, both wired inside 10 of said mask; controlled by a touch-to-talk button 11, incorporated into the lower chamber of said mask, wired inside 12 said mask; all of which are encapsulated into a waterproof plug 7a, exiting said mask in an umbilical cable 7b, plugging directly into a computer 14 within a waterproof case 13 positioned on the snorkeler. The configuration of a microphone in both the upper and lower chambers of said full-face snorkel mask 1000 allows the computer positioned on the snorkeler 14 to create noise-cancelling audio which can be transmitted to other snorkelers and a third-party monitor connected to said WLAN or a remote third-party monitor via a connection to the internet.

In various embodiments the FFSMCS as shown in FIG. 1 a camera in a waterproof case 15 is mounted on the top of the full-face snorkel mask 1000, wired 16 into said mask, encapsulated into a waterproof plug 7a, exiting said mask in an umbilical cable 7b, plugging into a computer 14 within a waterproof case 13 positioned on the snorkeler, allowing the user to broadcast images and video over the internet.

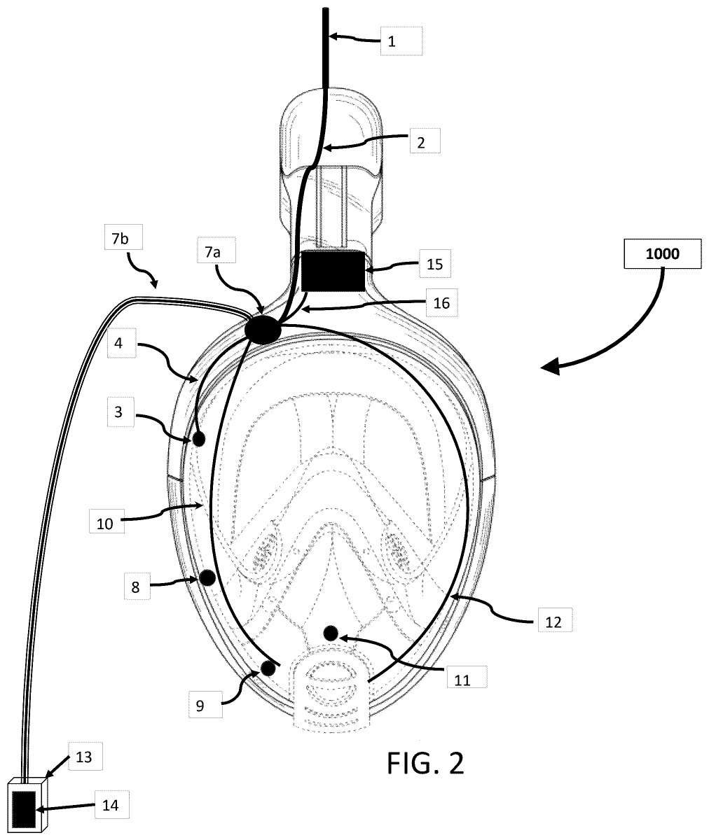

FIG. 2, illustrates an embodiment of the frontal view comprising said FFSMCS from FIG. 1.

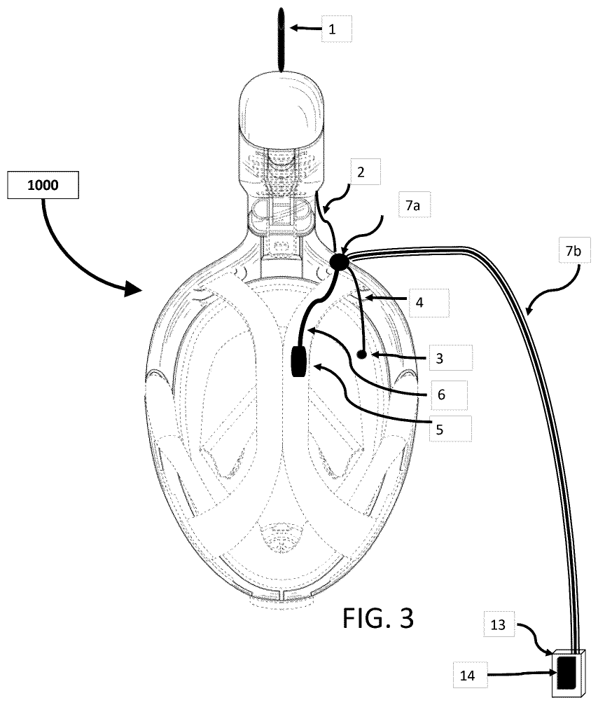

FIG. 3, illustrates an embodiment of the back view comprising said FFSMCS from FIG. 1.

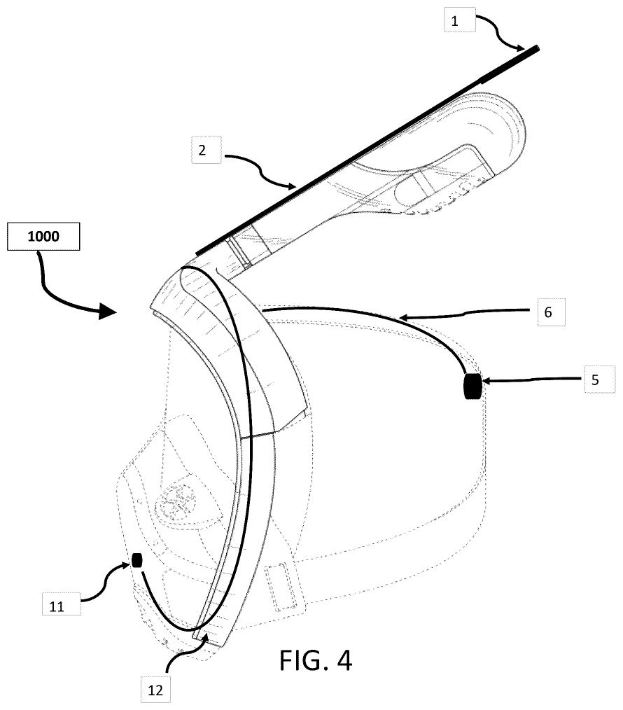

FIG. 4, illustrates an embodiment of a side-view comprising said FFSMCS from FIG. 1.

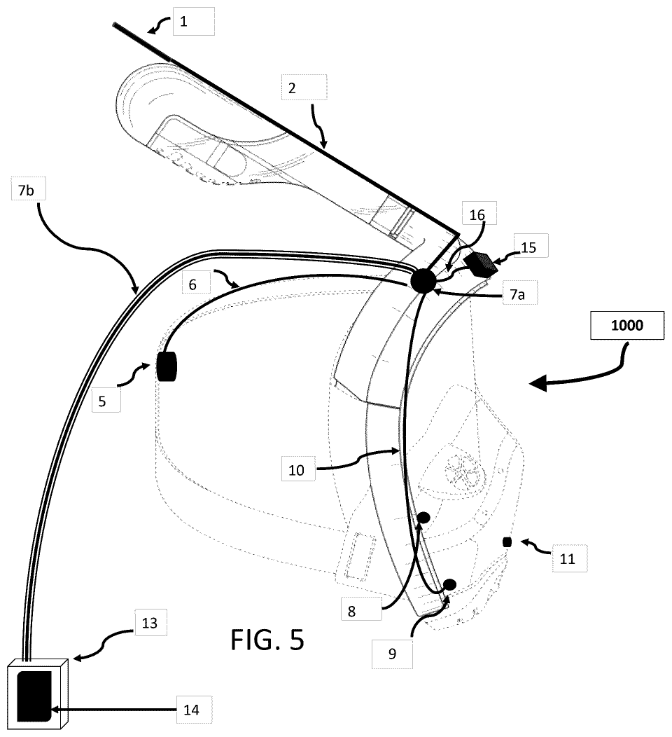

FIG. 5, illustrates an embodiment of the other side-view comprising said FFSMCS from FIG. 1.

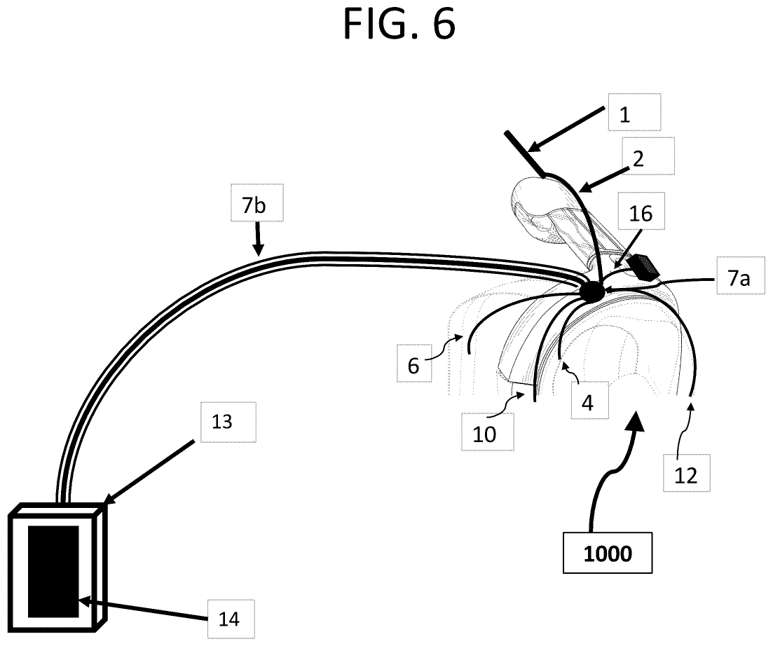

FIG. 6, illustrates an embodiment of the wiring of hardware components of the FFSMCS comprising: a WLAN antenna 1 affixed to the top of the snorkel breathing tube of a full-face snorkel mask 1000, wired into said mask 2; the bone-conducting speaker wired along the back of said mask 6; which are grouped in an umbilical cable 7b along with a waterproof plug 7a; said waterproof plug encapsulates the biometric sensor wiring 4, microphone wiring 10, push to talk button wiring 12, and camera wiring 16; allowing hardware components of the FFSMCS to be plugged directly into the computer positioned on the snorkeler 14 within a waterproof case 13.

In various embodiments of the FFSMCS, the computer 14 within the waterproof case 13 shown in FIGS. 1-8C can be any of the following, but not limited to: a Raspberry Pi computer; Arduino; Nvidia; a smart cellular phone; or a similar computer with a connection to the internet.

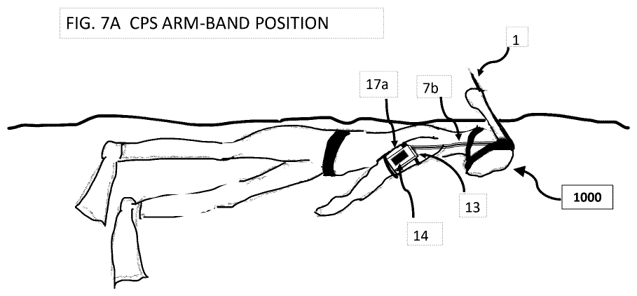

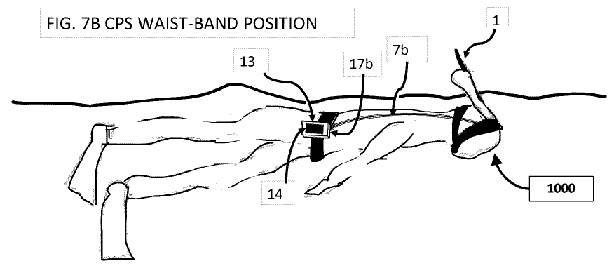

FIG. 7A, an embodiment of the FFSMCS comprising: a WLAN antenna 1 affixed to the top of the full-face snorkel mask 1000 breathing tube, connected to a wireless internet connection, which is grouped in an umbilical cable 7b, and wired directly into a computer 14 within a waterproof case 13, that can be positioned on the snorkeler's arm and can be attached using a band or strap 17a, allowing the snorkeler to position the computer on their body.

FIG. 7B, an embodiment of the FFSMCS may incorporate a WLAN antenna 1 affixed to the top of the full-face snorkel mask 1000 breathing tube, connected to a wireless internet connection, which is grouped in an umbilical cable 7b, and wired directly into a computer 14 within a waterproof case 13, that can be positioned on the waist of the snorkeler's bathing suit or wetsuit 17b, allowing the snorkeler to position the computer on their body.

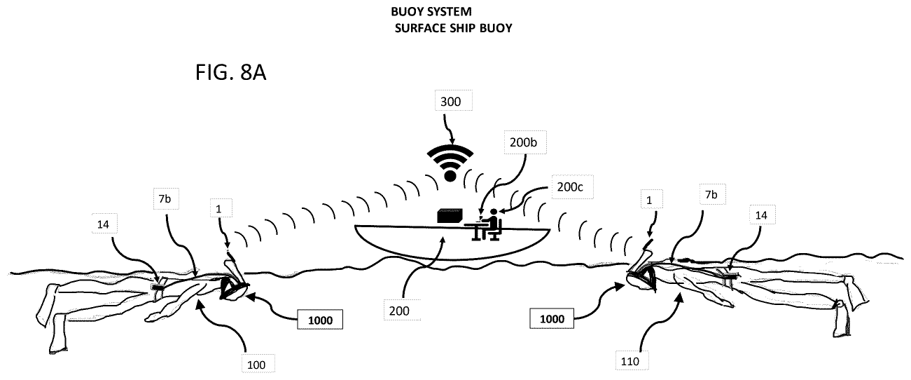

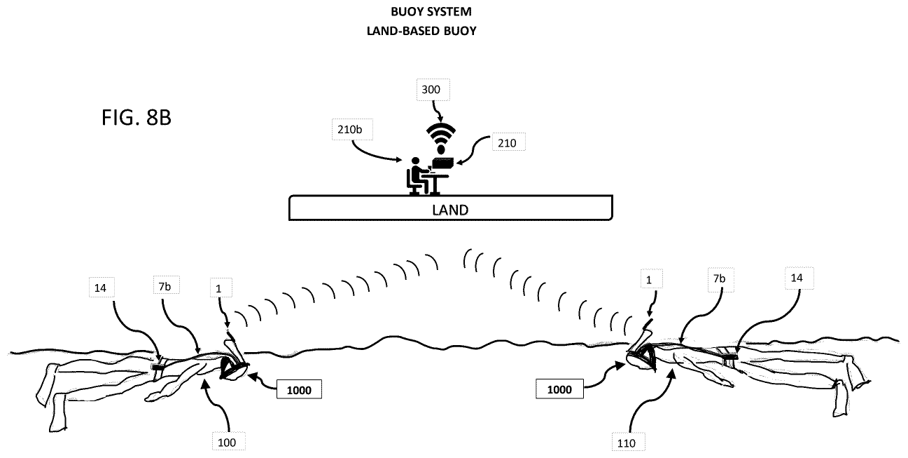

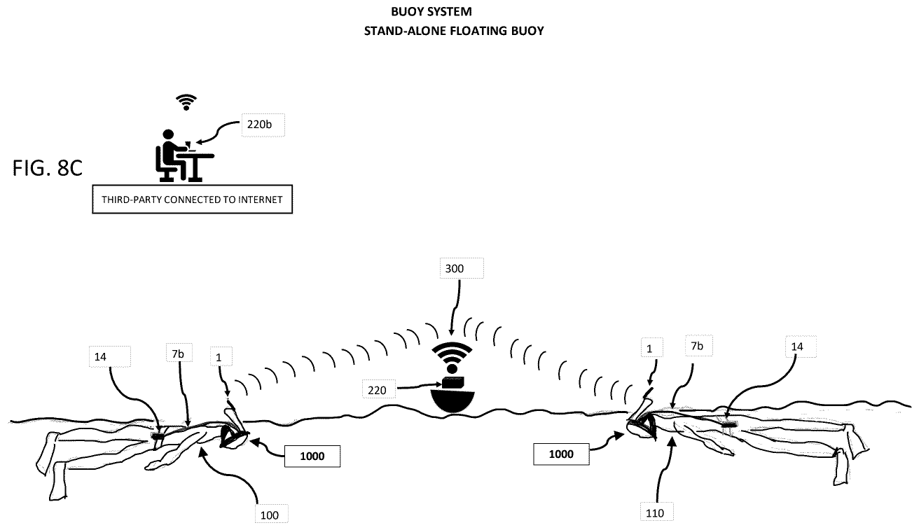

FIG. 8A, an embodiment of the FFSMCS provides a surface-ship buoy 200 with a buoy system computer 200b, connected to the internet that generates and broadcasts a WLAN 300; which enables two-way communication between a surface-ship monitor 200c and snorkel units comprising a WLAN antenna 1 affixed to the top of the full-face snorkel mask 1000 breathing tube, which is grouped in an umbilical cable 7b, and wired directly to a computer 14, that can be positioned on the arm of the snorkeler or the waist of the snorkeler's bathing suit; allowing a snorkeler 100 to communicate with one or more snorkelers 110 in the same group and connects all units to each other and the buoy system computer through the WLAN 300.

Various embodiments of the FFSMCS as shown in FIG. 8A enable a monitor 200c to do the following; send messages to one or more snorkel units, manage communication between snorkel units, GPS location tracking of all snorkel units, access biometric sensors, send and receive alarms or emergency alerts, and manage cloud broadcasting and interface of snorkel units, which provide an extra measure of safety for snorkelers.

FIG. 8B, an embodiment of the FFSMCS provides a land-based buoy computer system 210 connected to the internet that generates and broadcasts a WLAN 300, which enables two-way communication between a land-based monitor 210b and snorkel units comprising a WLAN antenna 1 affixed to the top of the full-face snorkel mask 1000 breathing tube, which is grouped in an umbilical cable 7b, and wired directly to a computer 14, that can be positioned on the arm of the snorkeler or the waist of the snorkeler's bathing suit; allowing a snorkeler 100 to communicate with one or more snorkelers 110 in the same group and connects all units to each other and the buoy system computer monitor, or a third-party monitor through the WLAN 300.

Various embodiments of the FFSMCS as shown in FIG. 8B enable a land-based monitor 210b to do the following; send messages to one or more snorkel units, manage communication between snorkel units, GPS location tracking of all snorkel units, access biometric sensors, send and receive alarms or emergency alerts, and manage cloud broadcasting and interface of snorkel units, which provide an extra measure of safety for snorkelers.

FIG. 8C, an embodiment of the FFSMCS provides a stand-alone floating buoy system computer 220 connected to the internet that generates and broadcasts a WLAN 300, which enables two-way communication between snorkel units comprising a WLAN antenna 1 affixed to the top of the full-face snorkel mask 1000 breathing tube, which is grouped in an umbilical cable 7b, and wired directly to a computer 14, that can be positioned on the arm of the snorkeler or the waist of the snorkeler's bathing suit; allowing a snorkeler 100 to communicate with one or more snorkelers 110 in the same group and connects all units to each other and the buoy system computer 220 through the WLAN 300, as well as a remote third-party monitor 200b who is connected to the internet.

Various embodiments of the FFSMCS as shown in FIG. 8C with a stand-alone floating buoy system computer 220 connected to the internet allows a member of the group 100 or a remote third-party 220b to do the following; send messages to one or more snorkel units, manage communication between snorkel units, GPS location tracking of all units, access biometric sensors, send and receive alarms or emergency alerts, and manage cloud broadcasting and interface of snorkel units, which provide an extra measure of safety for snorkelers.

What is claimed:

1. A communication system for a full-face snorkel mask, the system comprising:
a. a full-face snorkel mask including a transparent visor with two compartments, an upper chamber in the eyes and cheekbones area for viewing and a lower oronasal breathing chamber which allows the snorkeler to speak with their mouth, including a partition plate that separates the two chambers, a frame with a seal made of silicon to ensure a water-tight seal, suitable straps to fit the mask on the face of a snorkeler, a snorkel breathing tube upwardly extended from the top of said mask;
b. a Wi-Fi antenna fixed to the top of said breathing tube of said mask, positioned so that said antenna is above water while the face and visor of said snorkel mask is underwater;
c. said antenna wired directly to a computer in a waterproof case positioned on a snorkeler;
d. said computer is characterized in that it is able to connect to the internet and generate a WLAN via said antenna;
e. connecting said snorkeler to the internet and with other snorkelers on said WLAN;
which allows audio, video, and data communication between a plurality of snorkelers connected to said WLAN, with third-party monitors connected to said WLAN, and third-party monitors connected remotely via the internet.

2. The full-face snorkel mask communication system of claim 1 wherein said computer positioned on a snorkeler in a waterproof case, is at least one of the following with an internet connection:
a. a Raspberry Pi computer,
b. an Arduino,
c. a Nvidia,
d. a smart cell phone, or
e. other similar computers.

3. The full-face snorkel mask communication system of claim 2, wherein said computer in a waterproof case is positioned on said snorkeler on at least one of the following:
a. said snorkeler's arm, attached using a band or strap; or
b. coupled to the waist of said snorkeler's bathing suit or wetsuit.

4. The full-face snorkel mask communication system of claim 3, the system further comprising two waterproof microphones:
a. affixed inside said mask, one contained within the upper chamber and the second contained in the lower chamber of said mask;
b. said microphones wired directly to said computer positioned on snorkeler;
c. wherein said computer processes and creates noise-cancelling audio output;
allowing snorkelers to speak to other snorkelers on said WLAN, and to third-party monitors connected to said WLAN or remote third-party monitors connected to the internet.

5. The full-face snorkel mask communication system of claim 4 further comprising a bone-conducting transducer speaker:
a. positioned on a strap on the back of said mask, pressed against said snorkeler's skull;
b. wherein said speaker is wired directly to said computer positioned on said snorkeler;
allowing snorkelers to hear audio from other snorkelers on said WLAN, and from third-party monitors connected to said WLAN or remote third-party monitors connected to the internet.

6. The full-face snorkel mask communication system of claim 5 further comprising a biometric sensor:
a. affixed to the inside of the upper chamber of said mask pressed against the skin of the snorkeler;
b. wherein said sensor wiring plugs directly to said computer positioned on snorkeler;
allowing a third-party monitor to access biometric data, such as heart rate and oxygen levels, related to each snorkel unit on said WLAN, providing additional health and safety monitoring for snorkelers.

7. The full-face snorkel mask communication system of claim 6 further comprising a push- to-talk control button:
a. that is integrated into the front of said mask;
b. wherein said control button is wired directly to said computer positioned on snorkeler;
which allows the user direct control in sending audio communications to other snorkelers on the WLAN and to third-party monitors connected to the internet, as well as sharing video and audio to the internet via said WLAN.

8. The full-face snorkel mask communication system of claim 7 further comprising a camera in a waterproof case;
a. mounted to the top of said mask;
b. wherein said camera is wired directly to said computer positioned on snorkeler;
allowing the snorkeler to capture images and video and broadcast them to the internet via said WLAN.

9. The full-face snorkel mask communication system of claim 8, wherein said computer positioned on an individual snorkeler generates an internet connection and broadcasts it with said Wi-Fi antenna, creating a WLAN which allows the following:
a. processing of VOIP/SIP audio communication by said computer;
b. two-way audio, video, and data communication between said snorkelers and a third-party monitor connected to said WLAN;
c. two-way audio and data communication between snorkel units on said WLAN;
d. image sharing to the internet by snorkel units on said WLAN;
e. broadcast of video to the internet by snorkel units on said WLAN;
f. remote monitoring of snorkel units on said WLAN;
g. sending and receiving alerts and emergency warnings to snorkel units on said WLAN;
h. cloud-based broadcasting and interface on said computer;
i. cloud-based collaboration software which provides a forum and messaging application for a plurality of units which can be monitored by a third-party via the internet;
j. a third-party monitor connected to said WLAN is able to process data and monitor biometric sensors and GPS location tracking of said snorkel units.

10. The full-face snorkel mask communication system of claim 9, further comprising a buoy system with a buoy system computer which is at least one of the following with an internet connection:
a. a laptop; or
b. desktop computer.

11. The full-face snorkel mask communication system of claim 10, wherein said buoy system computer generates and broadcasts an internet connection via a Wi-Fi WLAN connecting:
a. a third-party monitor of said buoy system computer;
b. said buoy system computer to a plurality of snorkelers on said WLAN;
which allows audio, video, and data communication between said monitor of said buoy system computer, with a plurality of snorkelers connected to said WLAN, said snorkelers with one another, and third-party monitors connected remotely via the internet.

12. The full-face snorkel mask communication system of claim 11, wherein various embodiments of said buoy system is at least one of the following configurations:
a. a surface-ship buoy;
b. a land-based buoy; or
c. a stand-alone floating buoy.

13. The full-face snorkel mask communication system invention of claim 12, further comprising said buoy system computer with at least one of the following:
a. a WLAN router;
b. a WLAN-to-WLAN bridge, extender;
c. LoRaWAN;
d. a satellite interface;
e. a smart phone cellular connection;
f. a NOAA radio broadcast; or
g. a COSPAS-SARSAT satellite distress signal system.

14. The full-face snorkel mask communication system invention of claim 13, further comprising said buoy system computer connected to the internet, with a cloud system software interface, generating a Wi-Fi signal, and broadcasting a WLAN, enabling:
a. SIP/VOIP audio processing and broadcasting;
b. two-way audio, video, and data communication between said buoy system computer, snorkel units on said WLAN, and a remote third-party connected to the internet;
c. sending and receiving alerts and emergency warnings to said snorkel units;
d. a data sharing platform;
e. data processing and monitoring of biometric sensors;
f. GPS location tracking;
g. image and video capture, sharing, and transfer to the internet by said snorkel units,
h. cloud-based collaboration software which provides a forum and messaging application for a plurality of units which can be monitored by a third-party via the internet; and
i. remote monitoring of snorkel units on said WLAN via the internet.
